(19) United States
(12) Patent Application Publication
(10) Pub. No.: US 2026/0330109 A1
(43) Pub. Date: Oct. 22, 2026

(54) FLUID-STRUCTURE INTERACTION NUMERICAL CALCULATION METHOD FOR STUDYING FLUTTER CONTROL OF LONG-SPAN BRIDGES BY FRICTIONAL ENERGY DISSIPATION DEVICES

(71) Applicant: DALIAN UNIVERSITY OF TECHNOLOGY, Dalian (CN)

(72) Inventors: Fuyou XU, Dalian (CN); Wanbo AN, Dalian (CN); Zhanbiao ZHANG, Dalian (CN); Jie WANG, Dalian (CN); Mingjie ZHANG, Dalian (CN); Pinqing WANG, Dalian (CN)

(21) Appl. No.: 19/695,378

(22) Filed: Jun. 2, 2026

(30) Foreign Application Priority Data
Feb. 25, 2026 (CN) 202610222810.4

(51) Int. Cl. G06F 30/28; G06F 30/23; G06F 111/10; G06F 113/08

(52) U.S. Cl. CPC G06F 30/28; G06F 30/23; G06F 2111/10; G06F 2113/08

(57) ABSTRACT

The present invention belongs to the technical field of wind-induced vibration control of bridges, and discloses a fluid-structure interaction numerical calculation method for studying flutter control of long-span bridges by frictional energy dissipation devices. Based on computational fluid dynamics software Fluent, a secondary development program of a user-defined function is compiled by a dynamic mesh technology, and embedded into a solver for calculation. A motion equation of a rigid deck-frictional energy dissipation device coupling system in a wind field is established, and an alternating solving method of rigid deck motion and flow field motion is adopted to achieve fluid-structure interaction solving, to obtain the vertical and torsional motion responses of a controlled rigid deck. The method in the present invention can accurately set various parameters and stress modes of the rigid deck and frictional energy dissipation devices, can achieve full-scale simulation.

### TECHNICAL FIELD

The present invention belongs to the technical field of wind-induced vibration control of bridges, and relates to a fluid-structure interaction numerical calculation method for studying flutter control of long-span bridges by frictional energy dissipation devices.

### BACKGROUND

The spans of modern bridges are constantly increasing. Under the action of wind loads, various vibrations occur in bridge structures. As a divergent aerodynamic elasticity instability phenomenon, flutter is one of the most threatening vibration forms to bridge safety and must be strictly avoided.

To improve the wind resistance safety performance of long-span bridges, an effective technical approach is to introduce economical and efficient frictional energy dissipation devices to increase system damping and reduce amplitude. The authorized invention patent (Frictional Energy Dissipation Device for Controlling Flutter of Long-Span Bridges, CN119914639B) of the applicant discloses a frictional energy dissipation device for temporarily controlling flutter of long-span bridges. This device provides a safe and reliable, economical and rapid, efficient and practical possible solution for solving the problem of flutter control of long-span bridges.

To comprehensively and deeply study the control characteristics of this frictional energy dissipation device on bridge flutter, three methods can be adopted: theoretical analysis, wind tunnel experiment, and computational fluid dynamics (CFD). All the methods have relative advantages and disadvantages. At present, no related literature reports the specific processes of the three analysis methods and the analysis of the control effects on bridge flutter.

The present invention aims to develop a two-dimensional CFD numerical simulation technology to study the flutter control performance of frictional energy dissipation devices on a full-scale rigid deck of a bridge, so as to provide a basis for the optimization design of control solutions and parameters.

### SUMMARY

The present invention proposes a fluid-structure interaction numerical calculation method for studying the flutter control performance of frictional energy dissipation devices on a full-scale rigid deck of a bridge. Compared with a physical model test of rigid model, the parameter setting of this method can reach full scale, various resistance modes can be simulated, and full-scale or any scale ratio models can be simulated safely and efficiently to conveniently acquire refined dynamic response data of the deck and a surrounding flow field thereof, thereby providing a complete data basis for the energy dissipation mechanism revelation and performance optimization of the devices.

The technical solution of the present invention is as follows:

A fluid-structure interaction numerical calculation method for studying flutter control of long-span bridges by frictional energy dissipation devices comprises the following steps:
Step 1: determining a mechanical model and parameters of a rigid deck-frictional energy dissipation device coupling system, and establishing a motion equation of a rigid deck in a wind field under the action of frictional energy dissipation devices, wherein the frictional energy dissipation devices are the frictional energy dissipation devices for controlling flutter of long-span bridges in patent CN119914639B;
wherein the mechanical model of the rigid deck-frictional energy dissipation device coupling system that needs to be determined is composed of a rigid deck, frictional energy dissipation devices, anchoring cables, conveyer belts and weight blocks, wherein two identical frictional energy dissipation devices are symmetrically arranged on both sides of the bottom of the rigid deck along the longitudinal axis of the rigid deck; and one side of each frictional energy dissipation device is anchored to the ground through the anchoring cable, and the other side suspends the weight block through the conveyer belt.

The parameters of the rigid deck that need to be determined comprise a mass, a mass moment of inertia, a vertical motion damping coefficient, a torsional motion damping coefficient, a vertical motion stiffness, and a torsional motion stiffness of the rigid deck; the parameters of the frictional energy dissipation devices that need to be determined are the friction thresholds; and the parameters of the anchoring cables that need to be determined comprise the elastic modulus, the cross-sectional area and the length of the anchoring cables.

The motion equation of the rigid deck in the wind field under the action of the frictional energy dissipation devices comprises a vertical motion equation and a torsional motion equation:

m_{b}ÿ_{b}(t)+Cₚₕ\dot{y}_{b}(t)+Kₚₕy_{b}(t)=F_{w}(t)+F_{c}(t) (1)

J_{b}\ddot{α}_{b}(t)+C_{bα}\dot{α}_{b}(t)+K_{bα}α_{b}(t)=M_{w}(t)+M_{c}(t) (2)

where y_{b}, \dot{y}_{b} and ÿ_{b} represent displacement, velocity and acceleration of vertical motion of the rigid deck, respectively; α_{b}, \dot{α}_{b} and \ddot{α}_{b} represent torsional displacement, torsional velocity and torsional acceleration of the rigid deck about a longitudinal axis thereof, respectively; m; and J; are mass and mass moment of inertia per unit length of the rigid deck; Ch and Cba are a vertical motion damping coefficient and a torsional motion damping coefficient of the rigid deck, respectively; K_{bh} and K_{bα} are vertical motion stiffness and torsional motion stiffness of the rigid deck, respectively; F_{w}(t) and M_{w}(t) are an aerodynamic lift and an aerodynamic moment per unit length of the rigid deck, respectively; F_{c}(t) and M_{c}(t) are a vertical load and a moment applied to the rigid deck per unit length by the frictional energy dissipation device, respectively, expressed respectively as F_{c}(t)=−ΣF_{ci}(t) and M_{c}(t)=[F_{c1}(t)−F_{c2}(t)]×dₛ/2, i represents a serial number of the frictional energy dissipation devices, i=1, 2, 1 is a number of a left frictional energy dissipation device, 2 is a number of a right frictional energy dissipation device; F_{ci}(t) is a control force acting on the rigid deck by a No. i frictional energy dissipation device; dₛ is a distance between the frictional energy dissipation devices symmetrically arranged on both sides of the cross section of the rigid deck, wherein F_{c1}(t) and F_{c2}(t) are expressed respectively as:

$${F}_{c 1} = \{ \begin{matrix}{K}_{c 1} \cdot ( {y}_{c 1} - {y}_{cb 1} ) , & {y}_{c 1} - {y}_{cb 1} - {F}_{s 1} / {K}_{c 1} \geq 0 and {\dot{y}}_{c 1} > 0 \\ {F}_{s 1} , & {y}_{c 1} - {y}_{cb 1} - {F}_{s 1} / {K}_{c 1} < 0 and {\dot{y}}_{c 1} > 0 \\ 0 , & {y}_{c t 1} - {y}_{c 1} - {F}_{s 1} / {K}_{c 1} \geq 0 and {\dot{y}}_{c 1} \leq 0 \\ {K}_{c 1} \cdot ( {y}_{ct 1} - {y}_{c 1} ) , & {y}_{c t 1} - {y}_{c 1} - {F}_{s 1} / {K}_{c 1} < 0 and {\dot{y}}_{c 1} \leq 0\end{matrix} \qquad ( 3 )$$

$${F}_{c 2} = \{ \begin{matrix}{K}_{c 2} \cdot ( {y}_{c 2} - {y}_{cb 2} ) , & {y}_{c 2} - {y}_{cb 2} - {F}_{s 2} / {K}_{c 2} \geq 0 and {\dot{y}}_{c 2} > 0 \\ {F}_{s 2} , & {y}_{c 2} - {y}_{cb 2} - {F}_{s 2} / {K}_{c 2} < 0 and {\dot{y}}_{c 2} > 0 \\ 0 , & {y}_{c t 2} - {y}_{c 2} - {F}_{s 2} / {K}_{c 2} \geq 0 and {\dot{y}}_{c 2} \leq 0 \\ {K}_{c 2} \cdot ( {y}_{ct 2} - {y}_{c 2} ) , & {y}_{c t 2} - {y}_{c 2} - {F}_{s 2} / {K}_{c 2} < 0 and {\dot{y}}_{c 2} \leq 0\end{matrix} \qquad ( 4 )$$

where y_{c1} and \dot{y}_{c1} represent displacement and velocity at a connection point between the No. 1 frictional energy dissipation device and the rigid deck, respectively, expressed respectively as y_{c1}=y_{b}−0.5 dₛ·sin(α_{b}) and \dot{y}_{c1}=\dot{y}_{b}−0.5 dₛ·\dot{α}_{b}·cos(α_{b}); y_{c2} and \dot{y}_{c2} represent displacement and velocity at a connection point between the No. 2 frictional energy dissipation device and the rigid deck, respectively, expressed respectively as y_{c2}=y_{b}+0.5 dₛ·sin(α_{b}) and \dot{y}_{c2}=\dot{y}_{b}+0.5 dₛ·\dot{α}_{b}·cos(α_{b}); y_{cbi} and y_{cti} represent a minimum displacement value and a maximum displacement value at the connection point between the No. i frictional energy dissipation device and the rigid deck closest to a current calculation time t, respectively, and are identified through historical data of y_{ci} within adjacent time periods; Fₛ₁ and Fₛ₂ are the friction thresholds which are set for the No. 1 and No. 2 frictional energy dissipation devices, respectively, and are set to required values by adjusting the physical materials of the frictional energy dissipation devices; K_{c1} and K_{c2} are tensile stiffnesses of No. 1 and No. 2 anchoring cables, respectively, expressed respectively as K_{c1}=E₁A₁/l₁ and K_{c2}=E₂A₂/l₂, where E₁, A₁ and l₁ represent elastic modulus, cross-sectional area and length of the No. 1 anchoring cable, and E₂, A₂ and l₂ represent elastic modulus, cross-sectional area and length of the No. 2 anchoring cable, respectively.
Step 2: constructing, on the basis of the motion equation, a state equation of motion of the rigid deck in the wind field, thereby achieving order reduction processing of the motion equation;
rearranging equations (1) and (2) as:

ÿ_{b}(t)=[F_{w}(t)+F_{c}(t)−C_{bh}\dot{y}_{b}(t)−K_{bh}y_{b}(t)]/m_{b} (5)

\ddot{α}_{b}(t)=[M_{w}(t)+M_{c}(t)−C_{bα}\dot{α}_{b}(t)−K_{bα}α_{b}(t)]/J_{b} (6)
letting X(t)=[y_{b}(t), α_{b}(t), \dot{y}_{b}(t), \dot{α}_{b}(t)]^{T}, and rearranging equations (5) and (6) into the following first-order differential equation form to achieve order reduction of equations (1) and (2):

$$\dot{X} ( t ) = ( \begin{matrix}{\dot{y}}_{b} ( t ) \\ {\dot{α}}_{b} ( t ) \\ {\ddot{y}}_{b} ( t ) \\ {\ddot{α}}_{b} ( t )\end{matrix} ) = ( \begin{matrix}0 & 0 & 1 & 0 \\ 0 & 0 & 0 & 1 \\ - \frac{{K}_{bh}}{{m}_{b}} & 0 & - \frac{{C}_{bh}}{{m}_{b}} & 0 \\ 0 & - \frac{{K}_{b α}}{{J}_{b}} & 0 & - \frac{{C}_{b α}}{{J}_{b}}\end{matrix} ) ( \begin{matrix}{y}_{b} ( t ) \\ {α}_{b} ( t ) \\ {\dot{y}}_{b} ( t ) \\ {\dot{α}}_{b} ( t )\end{matrix} ) + ( \begin{matrix}0 \\ 0 \\ \frac{{F}_{w} ( t ) + {F}_{c} ( t )}{{m}_{b}} \\ \frac{{M}_{w} ( t ) + {M}_{c} ( t )}{{J}_{b}}\end{matrix} ) = AX ( t ) + B \qquad ( 7 )$$

wherein equation (7) is the state equation of motion of the rigid deck in the wind field; in numerical simulation calculation, as long as the aerodynamic force and the aerodynamic moment acting on the rigid deck from a wind load at each moment and the control force and the control moment acting on the rigid deck from the frictional energy dissipation devices are obtained, the fourth-order Runge-Kutta numerical calculation method is used to advance equation (7) in a time domain to calculate the displacement and velocity responses, y_{b}(t), α_{b}(t), \dot{y}_{b}(t) and \dot{α}_{b}(t), of the rigid deck.

Step 3: establishing a two-dimensional or three-dimensional geometric model of the rigid deck, determining a computational domain and boundary conditions of the wind field near the rigid deck, and dividing a flow field mesh.

The computational domain is a rectangular region or a cuboid region surrounding the rigid deck; the left side of the computational domain is a velocity inlet boundary; the right side of the computational domain is a pressure outlet boundary; the upper and lower sides of the computational domain are symmetrical boundaries; the surface of the rigid deck is a no-slip wall boundary; and the front and rear sides of the cuboid region are symmetrical boundaries; the distances from the left and right sides of the computational domain to the center of the rigid deck are 5 times and 15 times the width of the rigid deck, respectively; the distances from the upper and lower sides of the computational domain to the center of the rigid deck are both 5 times the width of the rigid deck; and the distance between the front and rear sides of the computational domain is the same as the width of the rigid deck.

In step 3, structured boundary layer meshes are provided in a region near the surface of the rigid deck, and structured boundary layer meshes or unstructured boundary layer meshes with gradually increasing sizes are provided in a region away from the wall surface of the rigid deck; the structured boundary layer meshes in the region near the surface of the rigid deck are not less than 10 layers, the first mesh layer ensures a dimensionless height y⁺≤1, the sizes of the boundary layer meshes gradually increase outwards, the height ratio of adjacent boundary layer meshes is not greater than 1.2, the unstructured boundary layer meshes in the region away from the wall surface of the rigid deck meet the principle of changing from dense to sparse, and the growth ratio between the sizes of the adjacent meshes is not greater than 1.2.

Step 4: importing the flow field mesh divided in step 3 into Fluent software, using a user-defined function (UDF) to compile a solving process of the state equation constructed in step 2, adopting an alternating solving method of flow field motion and deck motion to achieve fluid-structure interaction solving, obtaining the aerodynamic lift and the aerodynamic moment of the rigid deck after solving the flow field at each time step, calculating a control force and a control moment provided by the frictional energy dissipation device to the rigid deck according to the motion displacement and velocity of the deck, solving, on the basis of the aerodynamic lift, the aerodynamic moment, the control force and the control moment acting on the rigid deck, the vertical and torsional motion displacements of the rigid deck at a next time step using a fourth-order Runge-Kutta method, and then updating the flow field mesh according to the displacements.

Step 5: applying an initial displacement excitation to the rigid deck, solving the motion response time history of the deck under the action of the frictional energy dissipation devices after excitation, and then assessing the control effect of the control devices on flutter of the rigid deck.

The present invention has the following beneficial effects:
(1) The control effects and characteristics of the frictional energy dissipation devices on the flutter of the deck are conveniently and safely studied under various scaling conditions; (2) unaffected by physical space and model processing accuracy, various parameters and force modes of the deck and the frictional energy dissipation devices are accurately set as required; and (3) the time history of the mechanical device force acting on the deck during vibration and the motion or change process of the flow field near the deck are simultaneously monitored, which can facilitate in-depth study on the energy dissipation process and characteristics of the frictional energy dissipation devices.

### DESCRIPTION OF DRAWINGS

FIG. 1 is a mechanical model diagram of a rigid deck-frictional energy dissipation device system in an embodiment of the present invention.

FIG. 2 is a flow chart of a method in an embodiment of the present invention.

FIG. 3 is a sectional outline diagram of a deck in an embodiment of the present invention.

FIG. 4 shows a wind field computational domain and boundary conditions in an embodiment of the present invention.

FIG. 5 shows a flow field mesh of a wind field computational domain in an embodiment of the present invention: (a) is an overall region; (b) is a local region near a deck; (c) is a local region near a wall of the deck; and (d) is a local region near a wall of the deck.

FIG. 6 shows a flutter displacement time history of a deck without control (U=9 m/s): (a) is y_{b} and (b) is α_{b}.

FIG. 7 shows a flutter displacement time history of a deck after installation of frictional energy dissipation devices (U=20 m/s, K_{c}=9331 N/m and Fₛ=466.6 N): (a) is y_{b} and (b) is α_{b}.

FIG. 8 shows a flutter displacement time history of a deck after installation of frictional energy dissipation devices (U=25 m/s, K_{c}=16966 N/m and Fₛ=848.3 N): (a) is y_{b} and (b) is α_{b}.

FIG. 9 shows a flutter displacement time history of a deck after installation of frictional energy dissipation devices (U=30 m/s, K_{c}=23752 N/m and Fₛ=1187.6 N): (a) is y_{b} and (b) is α_{b}.

### DETAILED DESCRIPTION

Specific embodiments of the present invention are described below in detail in combination with the drawings and the technical solution.

The present embodiment takes the rigid deck flutter of the old Tacoma Narrows Bridge in the United States as a control object, and uses the method proposed by the present invention for simulation. It should be noted that the present invention has no special requirement for the cross-sectional form and the size of a deck, and is applicable to any cross-sectional form.

The rigid deck in the CFD numerical model of the present invention may adopt a two-dimensional geometric model and a three-dimensional geometric model, wherein the flow field simulation accuracy and the computation amount of the three-dimensional model are much higher than those of the two-dimensional geometric model, but the results are very close. Therefore, the present embodiment is described using the two-dimensional geometric model. In a specific implementation process, except that the mesh of the three-dimensional model in step 3 is obtained by stretching the mesh of the two-dimensional geometric model along a spanwise direction, the remaining steps are identical.

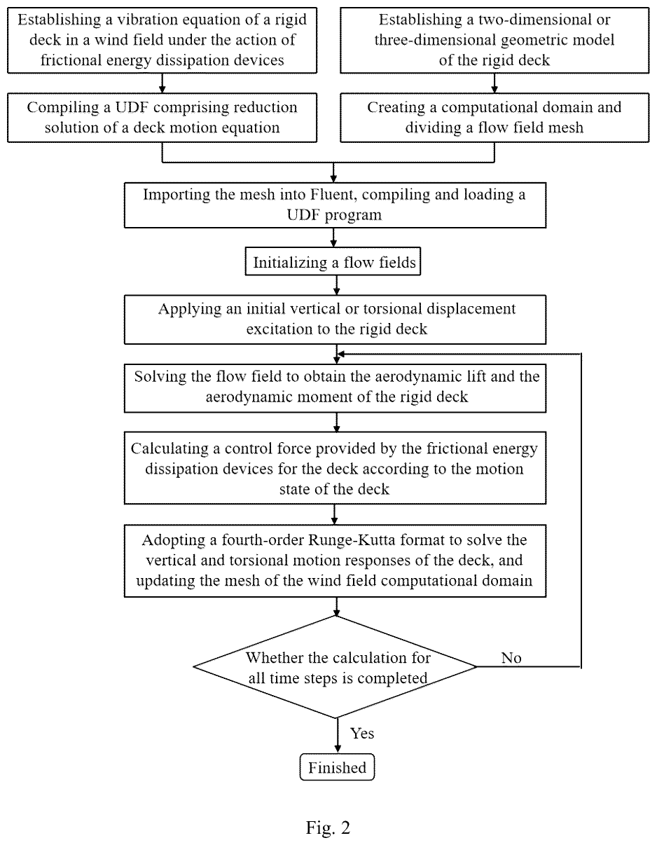

In the present embodiment, the control object is a full-scale unit-length rigid deck. Referring to the relevant structural parameters in the literature (Experimental Investigations on Nonlinear Flutter Performance of the Old Tacoma Narrows Bridge Deck under Skew Winds. Journal of Structural Engineering, 2025, 151 (7): 04025070), the parameters of the two-dimensional geometric model of the rigid deck are: deck length L_{b}=1 m, m_{b}=8483 kg, J_{b}=176824 kg·m², fₕ=0.145 Hz, f_{α}=0.2 Hz, C_{bh}=154.6 kg·rad/s, C_{bα}=4444.1 kg·m²·rad/s, K_{bh}=7041.1 N/m, K_{bα}=279229.3 N·m/rad, B=11.887 m, D=2.5 m, dₛ=11.875 m, K_{c1}=9331 N/m, K_{c2}=9331 N/m, Fₛ₁=466.6 N and Fₛ₂=466.6 N. The frictional energy dissipation devices on both sides adopt the same design parameters. By using the method of the present invention, the vertical and torsional motion responses of the rigid deck under different wind speeds U when the frictional energy dissipation devices are installed are obtained. An implementation flow chart is shown in FIG. 2, and specific operation steps are as follows:

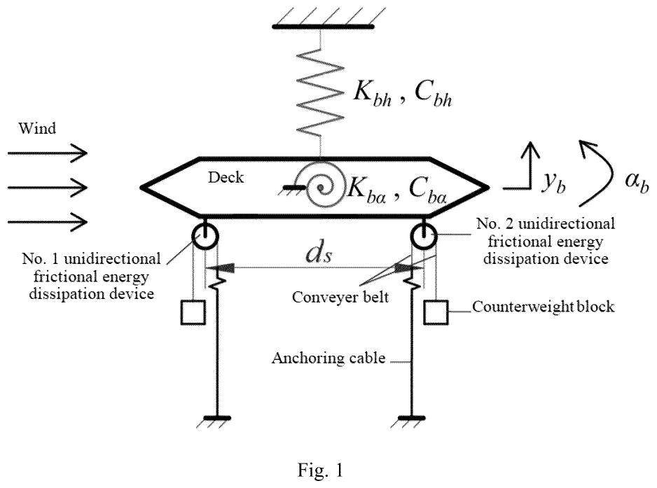

Step 1: determining a mechanical model (as shown in FIG. 1) and parameters of a rigid deck-frictional energy dissipation device coupling system, and establishing a motion equation of a rigid deck in a wind field under the action of frictional energy dissipation devices;

Step 2: constructing a state equation on the basis of the motion equation, thereby achieving order reduction processing of the motion equation;

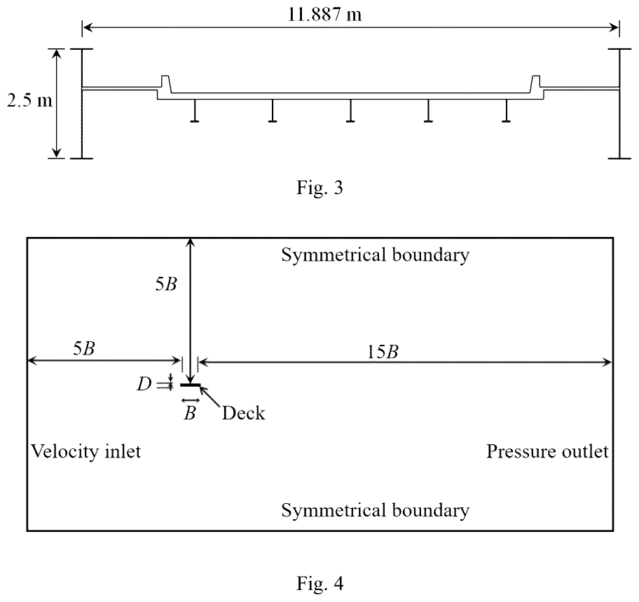

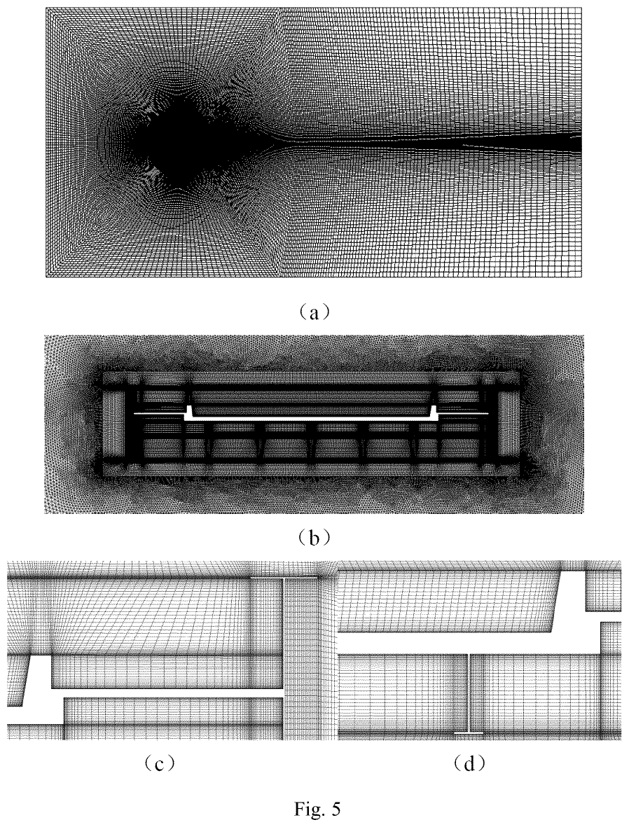

Step 3: establishing a two-dimensional geometric model of the rigid deck, with a sectional outline thereof shown in FIG. 3, determining a computational domain and boundary conditions of a two dimensional wind field, and dividing a flow field mesh, wherein the computational domain is a rectangular region surrounding the rigid deck, the left side of the computational domain is a velocity inlet boundary, the right side of the computational domain is a pressure outlet boundary, the upper and lower sides of the computational domain are symmetrical boundaries, and the surface of the rigid deck is a no-slip wall boundary; and the distances from the upper, lower, left and right boundaries of the computational domain to the center of the deck are 5, 5, 5 and 15 times the width of the deck, respectively, as shown in FIG. 4. The mesh of the wind field computational domain is shown in FIG. 5.

Step 4: importing the flow field mesh divided in step 3 into Fluent software, using a user-defined function (UDF) to compile a solving process of the state equation constructed in step 2, adopting an alternating solving method of flow field motion and deck motion to achieve fluid-structure interaction solving, obtaining the aerodynamic lift and the aerodynamic moment of the rigid deck after solving the flow field at each time step, calculating a control force and a control moment provided by the frictional energy dissipation device to the rigid deck according to the motion displacement and velocity of the deck, solving, on the basis of the aerodynamic lift, the aerodynamic moment, the control force and the control moment acting on the rigid deck, the vertical and torsional motion displacements of the rigid deck at a next time step using a fourth-order Runge-Kutta method, and then updating the flow field mesh according to the displacements. The mesh update of the computational domain adopts a smoothing method based on a diffusion equation, and the mesh point displacement is inversely proportional to the 1.5th power of the minimum range from the surface of the deck;

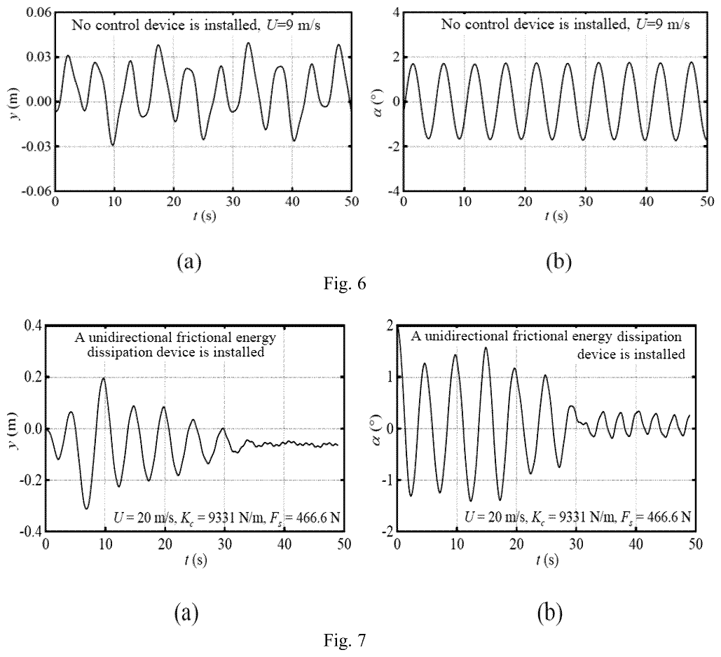

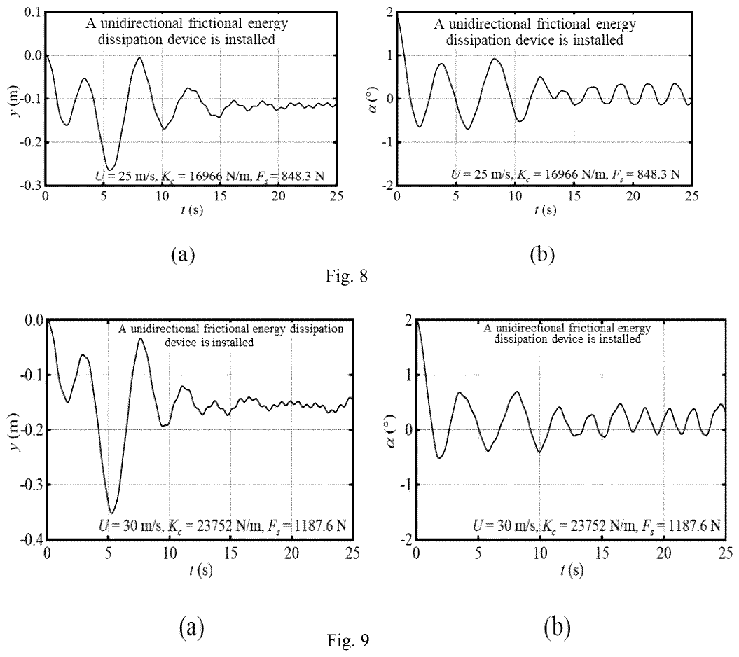

Step 5: applying an initial vertical displacement or torsional displacement excitation (e.g., torsional displacement of) 2° to the rigid deck, solving the motion response time history of the rigid deck under the action of the frictional energy dissipation devices after excitation, comparing the same with the flutter response of an uncontrolled structure and then assessing the control effect on the flutter of the rigid deck. The vertical and torsional displacement time histories of the deck under different wind speeds and frictional energy dissipation device parameters in uncontrolled and controlled states are shown in FIGS. 6-9, respectively. It can be seen that the numerical simulation calculation method of the present invention can study the control effect of the frictional energy dissipation devices on bridge flutter, and the results indicate that the vibration control is very efficient.

The present invention is not limited to the above embodiments. On the basis of the technical solution disclosed in the present invention, those skilled in the art can make some substitutions and modifications to some of the technical features according to the disclosed technical content, without creative effort, and these substitutions and modifications are all within the protection scope of the present invention.

1. A fluid-structure interaction numerical calculation method for studying flutter control of long-span bridges by frictional energy dissipation devices, comprising the following steps:
step 1: determining a mechanical model and parameters of a rigid deck-frictional energy dissipation device coupling system, and establishing a motion equation of a rigid deck in a wind field under the action of frictional energy dissipation devices;
wherein in step 1, the motion equation of the rigid deck in the wind field under the action of the frictional energy dissipation devices comprises a vertical motion equation and a torsional motion equation:
m_{b}ÿ_{b}(t)+C_{bh}\dot{y}_{b}(t)+K_{bh}y_{b}(t)=F_{w}(t)+F_{c}(t) (1)
J_{b}\ddot{α}_{b}(t)+C_{bα}\dot{α}_{b}(t)+K_{bα}α_{b}(t)=M_{w}(t)+M_{c}(t) (2)
where y_{b}, \dot{y}_{b} and ÿ_{b} represent displacement, velocity and acceleration of vertical motion of the rigid deck, respectively; α_{b}, \dot{α}_{b} and \ddot{α}_{b} represent torsional displacement, torsional velocity and torsional acceleration of the rigid deck about a longitudinal axis thereof, respectively; m_{b} and J_{b} are mass and mass moment of inertia per unit length of the rigid deck; C_{bh} and C_{bα} are a vertical motion damping coefficient and a torsional motion damping coefficient of the rigid deck, respectively; K_{bh} and K_{bα} are vertical motion stiffness and torsional motion stiffness of the rigid deck, respectively; F_{w}(t) and M_{w}(t) are an aerodynamic lift and an aerodynamic moment per unit length of the rigid deck, respectively; F_{c}(t) and M_{c}(t) are a vertical load and a moment applied to the rigid deck per unit length by the frictional energy dissipation device, respectively, expressed respectively as F_{c}(t)=−ΣF_{ci}(t) and M_{c}(t)=[F_{c1}(t)−F_{c2}(t)]×dₛ/2, i represents a serial number of the frictional energy dissipation devices, i=1, 2, 1 is a number of a left frictional energy dissipation device, 2 is a number of a right frictional energy dissipation device; F_{ci}(t) is a control force acting on the rigid deck by a No. i frictional energy dissipation device; dₛ is a distance between the frictional energy dissipation devices symmetrically arranged on both sides of the cross section of the rigid deck, wherein F_{c1}(t) and F_{c2}(t) are expressed respectively as:
$${F}_{c 1} = \{ \begin{matrix}{K}_{c 1} \cdot ( {y}_{c 1} - {y}_{cb 1} ) , & {y}_{c 1} - {y}_{cb 1} - {F}_{s 1} / {K}_{c 1} \geq 0 and {\dot{y}}_{c 1} > 0 \\ {F}_{s 1} , & {y}_{c 1} - {y}_{cb 1} - {F}_{s 1} / {K}_{c 1} < 0 and {\dot{y}}_{c 1} > 0 \\ 0 , & {y}_{c t 1} - {y}_{c 1} - {F}_{s 1} / {K}_{c 1} \geq 0 and {\dot{y}}_{c 1} \leq 0 \\ {K}_{c 1} \cdot ( {y}_{ct 1} - {y}_{c 1} ) , & {y}_{c t 1} - {y}_{c 1} - {F}_{s 1} / {K}_{c 1} < 0 and {\dot{y}}_{c 1} \leq 0\end{matrix} \qquad ( 3 )$$
$${F}_{c 2} = \{ \begin{matrix}{K}_{c 2} \cdot ( {y}_{c 2} - {y}_{cb 2} ) , & {y}_{c 2} - {y}_{cb 2} - {F}_{s 2} / {K}_{c 2} \geq 0 and {\dot{y}}_{c 2} > 0 \\ {F}_{s 2} , & {y}_{c 2} - {y}_{cb 2} - {F}_{s 2} / {K}_{c 2} < 0 and {\dot{y}}_{c 2} > 0 \\ 0 , & {y}_{c t 2} - {y}_{c 2} - {F}_{s 2} / {K}_{c 2} \geq 0 and {\dot{y}}_{c 2} \leq 0 \\ {K}_{c 2} \cdot ( {y}_{ct 2} - {y}_{c 2} ) , & {y}_{c t 2} - {y}_{c 2} - {F}_{s 2} / {K}_{c 2} < 0 and {\dot{y}}_{c 2} \leq 0\end{matrix} \qquad ( 4 )$$
where y_{c1} and \dot{y}_{c1} represent displacement and velocity at a connection point between the No. 1 frictional energy dissipation device and the rigid deck, respectively, expressed respectively as y_{c1}=y_{b}−0.5 dₛ·sin(α_{b}) and \dot{y}_{c1}=\dot{y}ₚ−0.5 dₛ·\dot{α}_{b}·cos(α_{b}); y_{c2} and \dot{y}_{c2} represent displacement and velocity at a connection point between the No. 2 frictional energy dissipation device and the rigid deck, respectively, expressed respectively as y_{c2}=y_{b}+0.5 dₛ·sin(α_{b}) and \dot{y}_{c2}=\dot{y}_{b}+0.5 dₛ·α_{b}·cos(α_{b}); y_{cbi} and y_{cti} represent a minimum displacement value and a maximum displacement value at the connection point between the No. i frictional energy dissipation device and the rigid deck closest to a current calculation time t, respectively, and are identified through historical data of y_{ci} within adjacent time periods; Fₛ₁ and Fₛ₂ are the friction thresholds which are set for the No. 1 and No. 2 frictional energy dissipation devices, respectively, and are set to required values by adjusting the physical materials of the frictional energy dissipation devices; K_{c1} and K_{c2} are tensile stiffnesses of No. 1 and No. 2 anchoring cables, respectively, expressed respectively as K_{c1}=E₁A₁/l₁ and K_{c2}=E₂A₂/l₂, where E₁, A₁ and l₁ represent elastic modulus, cross-sectional area and length of the No. 1 anchoring cable, and E₂, A₂ and l₂ represent elastic modulus, cross-sectional area and length of the No. 2 anchoring cable, respectively;
step 2: constructing, on the basis of the motion equation, a state equation of motion of the rigid deck in the wind field, thereby achieving order reduction processing of the motion equation;
step 3: establishing a two-dimensional or three-dimensional geometric model of the rigid deck, determining a computational domain and boundary conditions of the wind field near the rigid deck, and dividing a flow field mesh;
step 4: importing the flow field mesh divided in step 3 into Fluent software, using a user-defined function to compile a solving process of the state equation constructed in step 2, adopting an alternating solving method of flow field motion and deck motion to achieve fluid-structure interaction solving, obtaining the aerodynamic lift and the aerodynamic moment of the rigid deck after solving the flow field at each time step, calculating a control force and a control moment provided by the frictional energy dissipation device to the rigid deck according to the motion displacement and velocity of the rigid deck, solving, on the basis of the aerodynamic lift, the aerodynamic moment, the control force and the control moment acting on the rigid deck, the vertical and torsional motion displacements of the rigid deck at a next time step using a fourth-order Runge-Kutta method, and then updating the flow field mesh according to the displacements.

2. The fluid-structure interaction numerical calculation method for studying flutter control of long-span bridges by frictional energy dissipation devices according to claim 1, wherein the mechanical model of the rigid deck-frictional energy dissipation device coupling system that needs to be determined in step 1 is composed of a rigid deck, frictional energy dissipation devices, anchoring cables, conveyer belts and weight blocks, wherein two identical frictional energy dissipation devices are symmetrically arranged on both sides of the bottom of the rigid deck along the longitudinal axis of the rigid deck; and one side of each frictional energy dissipation device is anchored to the ground through the anchoring cable, and the other side suspends the weight block through the conveyer belt.

3. The fluid-structure interaction numerical calculation method for studying flutter control of long-span bridges by frictional energy dissipation devices according to claim 2, wherein the parameters of the rigid deck that need to be determined in step 1 comprise a mass, a mass moment of inertia, a vertical motion damping coefficient, a torsional motion damping coefficient, a vertical motion stiffness, and a torsional motion stiffness of the rigid deck; the parameters of the frictional energy dissipation devices that need to be determined are the friction thresholds; and the parameters of the anchoring cables that need to be determined comprise the elastic modulus, the cross-sectional area and the length of the anchoring cables.

4. The fluid-structure interaction numerical calculation method for studying flutter control of long-span bridges by frictional energy dissipation devices according to claim 3, wherein the order reduction processing of the motion equation in step 2 comprises: rearranging equations (1) and (2) as:
ÿ_{b}(t)=[F_{w}(t)+F_{c}(t)−C_{bh}\dot{y}_{b}(t)−K_{bh}y_{b}(t)]/m_{b} (5)
\ddot{α}_{b}(t)=[M_{w}(t)+M_{c}(t)−C_{bα}\dot{α}_{b}(t)−K_{bα}α_{b}(t)]/J_{b} (6)
letting X(t)=[y_{b}(t), α_{b}(t), \dot{y}_{b}(t), \dot{α}_{b}(t)]^{T}, and rearranging equations (5) and (6) into the following first-order differential equation form to achieve order reduction of equations (1) and (2):
$$\dot{X} ( t ) = ( \begin{matrix}{\dot{y}}_{b} ( t ) \\ {\dot{α}}_{b} ( t ) \\ {\ddot{y}}_{b} ( t ) \\ {\ddot{α}}_{b} ( t )\end{matrix} ) = ( \begin{matrix}0 & 0 & 1 & 0 \\ 0 & 0 & 0 & 1 \\ - \frac{{K}_{bh}}{{m}_{b}} & 0 & - \frac{{C}_{bh}}{{m}_{b}} & 0 \\ 0 & - \frac{{K}_{b α}}{{J}_{b}} & 0 & - \frac{{C}_{b α}}{{J}_{b}}\end{matrix} ) ( \begin{matrix}{y}_{b} ( t ) \\ {α}_{b} ( t ) \\ {\dot{y}}_{b} ( t ) \\ {\dot{α}}_{b} ( t )\end{matrix} ) + ( \begin{matrix}0 \\ 0 \\ \frac{{F}_{w} ( t ) + {F}_{c} ( t )}{{m}_{b}} \\ \frac{{M}_{w} ( t ) + {M}_{c} ( t )}{{J}_{b}}\end{matrix} ) = AX ( t ) + B \qquad ( 7 )$$
wherein equation (7) is the state equation of motion of the rigid deck in the wind field; in numerical simulation calculation, as long as the aerodynamic force and the aerodynamic moment acting on the rigid deck from a wind load at each moment and the control force and the control moment acting on the rigid deck from the frictional energy dissipation devices are obtained, the fourth-order Runge-Kutta numerical calculation method is used to advance equation (7) in a time domain to calculate the displacement and velocity responses, y_{b}(t), α_{b}(t), \dot{y}_{b}(t) and α_{b}(t), of the rigid deck.

5. The fluid-structure interaction numerical calculation method for studying flutter control of long-span bridges by frictional energy dissipation devices according to claim 4, wherein in step 3, the computational domain is a rectangular region or a cuboid region surrounding the rigid deck; the left side of the computational domain is a velocity inlet boundary; the right side of the computational domain is a pressure outlet boundary; the upper and lower sides of the computational domain are symmetrical boundaries; the surface of the rigid deck is a no-slip wall boundary; and the front and rear sides of the cuboid region are symmetrical boundaries; the distances from the left and right sides of the computational domain to the center of the rigid deck are 5 times and 15 times the width of the rigid deck, respectively; the distances from the upper and lower sides of the computational domain to the center of the rigid deck are both 5 times the width of the rigid deck; and the distance between the front and rear sides of the computational domain is the same as the width of the rigid deck.

6. The fluid-structure interaction numerical calculation method for studying flutter control of long-span bridges by frictional energy dissipation devices according to claim 5, wherein a method for dividing the flow field mesh in step 3 comprises: providing structured boundary layer meshes in a region near the surface of the rigid deck, and providing structured boundary layer meshes or unstructured boundary layer meshes with gradually increasing sizes in a region away from the wall surface of the rigid deck, wherein the structured boundary layer meshes in the region near the surface of the rigid deck are not less than 10 layers, the first mesh layer ensures a dimensionless height y⁺≤1, the sizes of the boundary layer meshes gradually increase outwards, the height ratio of adjacent boundary layer meshes is not greater than 1.2, the unstructured boundary layer meshes in the region away from the wall surface of the rigid deck meet the principle of changing from dense to sparse, and the growth ratio between the sizes of the adjacent meshes is not greater than 1.2.
